(19) United States
(12) Patent Application Publication
(10) Pub. No.: US 2020/0407664 A1
(43) Pub. Date: Dec. 31, 2020

(54) LAUNDRY COMPOSITION

(71) Applicant: Conopco, Inc., d/b/a UNILEVER, Englewood Cliffs, NJ (US)

(72) Inventor: Martin Charles CROSSMAN, Eastham, Wirral (GB)

(73) Assignee: Conopco, Inc., d/b/a UNILEVER, Englewood Cliffs, NJ (US)

(21) Appl. No.: 16/971,592

(22) PCT Filed: Feb. 19, 2019
(86) PCT No.: PCT/EP2019/054076

§ 371 Date: Aug. 20, 2020

(30) Foreign Application Priority Data
Mar. 2, 2018 (EP) 18159783.2

(51) Int. Cl. C11D 3/00; C11D 3/37; C11D 3/22

(52) U.S. Cl. CPC C11D 3/0036; C11D 3/0015; C11D 3/222; C11D 3/3773; C11D 3/373; C11D 3/3765

(57) ABSTRACT

A laundry composition comprising: a. Soil release polymer b. Silicone c. Cationic polymer d. Surfactant e. Water

### FIELD OF THE INVENTION

The present invention relates to a laundry composition providing improved softening to fabrics. In particular laundry compositions providing softening to knitted cotton.

### BACKGROUND OF THE INVENTION

Textile fabrics, including clothes can often feel harsh after the laundry process. To reduce the harshness experienced after multiple wash cycles, consumers seek care benefits from their laundry products. This is a particular issue for knitted cotton fabrics. Knitted cotton is a particularly soft fabric and maintaining this softness is a priority for many consumers.

There is a need to improve the softening performance provided by the fabric treatment compositions. The compositions of the present invention provide a laundry composition with enhanced softening of knitted cotton.

### SUMMARY OF THE INVENTION

In a first aspect of the present invention, there is provided a laundry composition comprising:
a. Soil release polymer
b. Silicone
c. Cationic polymer
d. Surfactant
e. Water

In a second aspect of the present invention, there is provided a method for softening knitted cotton, wherein the knitted cotton is treated with a composition according to the invention.

In a third aspect of the present invention, there is provided a use of the composition according to the invention for softening knitted cotton.

It is known that soil release polymers do not deposit on cotton material, however surprisingly a synergy has been found to exist between soil release polymers and silicone polymers which leads to improved softening of knitted cotton.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Form of the Invention

The invention may take any number of forms that are laundry compositions. Examples include powders, granules, bars, gels and liquids.

Preferably the composition is in the form of a liquid laundry product. Preferably they are main wash products. It can take the form of a laundry composition for the main wash, which may be dilutable or non-dilutable. A liquid laundry detergent according to the invention (may generally comprise from 5 to 95%, preferably from 10 to 90%, more preferably from 15 to 85% water (by weight based on the total weight of the composition).

### Soil Release Polymer

Suitable soil release polymers can be synthesised by conventional techniques well-known the skilled person, such as those described in US 2013/0200290.

Soil release polymers may be present at a level selected from: less than 7.5%, less than 5%, and less than 2.5%, by weight of the laundry composition. Soil release polymers may be present at a level selected from: more than 0.005%, more than 0.01%, and more than 0.05%, by weight of the composition. Suitably Soil release polymers is present in the composition in an amount selected from the range of from about 0.005% to about 7.5%, preferably from about 0.01% to about 5%, more preferably from about 0.05% to about 2.5%, by weight of the composition.

The soil release polymer has one or more fabric-binding regions, to provide fabric substantively. For example, the soil release polymer may include a fabric-binding region capped by one or more hydrophilic regions. Typically, the fabric-binding region forms the central portion of the molecule (the “midblock”) and is capped by hydrophilic groups. The anionic substituents are provided on the fabric-binding region and/or on the end cap, since these disrupt surfactant interaction with the soil release polymer.

The weight average molecular weight of the polymeric soil release polymer may be at least 1,000, at least 2,000, at least 5,000, at least 10,000, at least 15,000, at least 20,000 or at least 25,000. The upper limit for the weight average molecular weight may be, for example, 100,000; 75,000; 60,000; 55,000; 50,000; 40,000 or 30,000. For example, the weight average molecular weight may be between about 5,000 to about 50,000, such as between about 1,200 to 12,000.

Preferably the soil release polymers of the present invention are polymers according to the following generic formula:

X₁—R₁—Z—R₂—X₂ Formula (I)

### Wherein:

X₁ and X₂ are independently capping moieties
R₁ and R₁ are independently one or more nonionic hydrophilic blocks
Z is one or more anionic hydrophobic blocks

X₁ and X2 are independently, preferably, alkyl groups, more preferably C₁₋₄ alkyl branched or unbranched moieties.

R₁ and R₁ are independently, preferably blocks consisting of one or more nonionic hydrophilic components selected from:
(i) polyoxyethylene segments with a degree of polymerization of at least 2, preferably from 3 to about 150, more preferably from 6 to about 100 or
(ii) polyoxypropylene segments with a degree of polymerization of at least 2, or
(iii) oxypropylene or polyoxypropylene segments with a degree of polymerization of from 2 to 10, wherein said hydrophile segment does not encompass any oxypropylene unit unless it is bonded to adjacent moieties at each end by ether linkages, or
(iv) a mixture of oxyalkylene units comprising oxyethylene and from 1 to about 30 oxypropylene units wherein said mixture contains a sufficient amount of oxyethylene units such that the hydrophile component has hydrophilicity great enough to increase the hydrophilicity of conventional polyester synthetic fiber surfaces upon deposit of the soil release agent on such surface, said hydrophile segments preferably comprising at least about 25% oxyethylene units and more preferably, especially for such components having about 20 to 30 oxypropylene units, at least about 50% oxyethylene units; or
(v) oxypropylene and/or polyoxypropylene segments in the terminal positions of the polymer chain.

Z preferably consists of one or more anionic hydrophobic components selected from:
(i) C₃ oxyalkylene terephthalate segments, wherein, if said hydrophobe components also comprise oxyethylene terephthalate, the ratio of oxyethylene terephthalate: C₃ oxyalkylene terephthalate units is about 2:1 or lower, where the terephthalate segments are at least partially sulphonated
(ii) C4 -C6 alkylene or oxy C4 -C6 alkylene segments, or mixtures therein, preferably these segments include, but are not limited to, end-caps of polymeric soil release agents such as MO3 S(CH2)n OCH2 CH2O—, where M is sodium and n is an integer from 4-6, as disclosed in U.S. Pat. No. 4,721,580, issued Jan. 26, 1988 to Gosselink,
(iii) poly (vinyl ester) segments, preferably polyvinyl acetate), having a degree of polymerization of at least 2, or (iv) C1-C4 alkyl ether or C4 hydroxyalkyl ether substituents, or mixtures therein, wherein said substituents are present in the form of C1-C4 alkyl ether or C4 hydroxyalkyl ether cellulose derivatives, or mixtures therein, and such cellulose derivatives are amphiphilic, whereby they have a sufficient level of C1-C4 alkyl ether and/or C4 hydroxyalkyl ether units to deposit upon conventional polyester synthetic fiber surfaces and retain a sufficient level of hydroxyls, once adhered to such conventional synthetic fiber surface, to increase fiber surface hydrophilicity, or a combination of (a) and (b). preferably these segements include graft copolymers of poly(vinyl ester), e.g., C1-C6 vinyl esters, preferably poly(vinyl acetate) grafted onto polyalkylene oxide backbones, such as polyethylene oxide backbones. See European Patent Application 0 219 048, published Apr. 22, 1987 by Kud, et al. Commercially available soil release agents of this kind include the SOKALAN type of material, e.g., SOKALAN HP-22, available from BASF (West Germany).
(iv) isophthalate groups, such as a 1, 4-phenylene moiety or a 1, 3-phenylene moiety having 0 to 4 anionic substituents (such as carboxylate, phosphonate, phosphate or, preferably sulphonate), preferably 1, 4-phenylene moiety having 0 to 4 anionic substituents.

Preferably, the Z is a polyester polymer or comprises a polyester copolymer region.

In one preferred example, the soil release polymer may be according to the following formula (II)

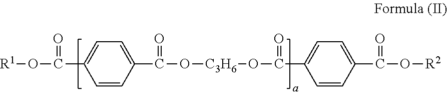

wherein
R¹ and R² independently of one another are X—(OC₂H₄)ₙ—(OC₃H₆)ₘ, wherein X is C₁₋₄ alkyl, the —(OC₂H₄) groups and the —(OC₃H₆) groups are arranged blockwise and the block consisting of the —(OC₃H₆) groups is bound to a COO group or are HO—(C₃H₆),
n is based on a molar average a number of from 12 to 120 and preferably of from 40 to 50,
m is based on a molar average a number of from 1 to 10, and
a is based on a molar average a number of from 4 to 9 and

In the polymer of formula (I), “X” of R¹ and R² is preferably methyl.

In the polymer of formula (I), the —(OC₃H₆) groups of R¹ and R² is preferably bound to a COO group.

In the polymer of formula (I), the variable “n” based on a molar average preferably is a number of from 40 to 50, more preferably is a number of from 43 to 47 and even more preferably is 44 to 46 and most preferably 45.

In the polymer of formula (I), the variable “m” based on a molar average preferably is a number of from 1 to 7, more preferably a number from 2 to 6.

In the polymer of formula (I), the variable “a” based on a molar average preferably is a number of from 5 to 8 and more preferably is a number of from 6 to 7.

The groups —O—C₂H₄— in the structural units “X—(OC₂H₄)ₙ—(OC₃H₆)ₘ” or “H₃C—(OC₂H₄)ₙ—(OC₃H₆)ₘ” are of the formula —O—CH₂—CH₂—.

The groups —O—C₃H₆— in the structural units indexed with “a”, in the structural units “X—(OC₂H₄)ₙ—(OC₃H₆)ₘ” or “H₃C—(OC₂H₄)ₙ—(OC₃H₆)ₘ” and in the structural units HO—(C₃H₆) are of the formula —O—CH(CH₃)—CH₂— or —O—CH₂—CH(CH₃)—, i.e. are of the formula

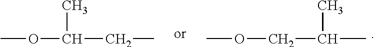

In one particularly preferred embodiment of the invention the polyesters of component A) of the inventive compositions are according to the following formula (I)

R¹ and R² independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group,
n is based on a molar average a number of from 44 to 46,
m is based on a molar average 2, and
a is based on a molar average a number of from 5 to 8.

And more preferably:

R¹ and R² independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group,
n is based on a molar average 45,
m is based on a molar average 2, and
a is based on a molar average a number of from 6 to 7
are especially preferred.

In an alternate particularly preferred embodiment of the invention the polyesters of component A) of the inventive compositions are according to the following formula (I)

R¹ and R² independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group,

n is based on a molar average a number of from 44 to 46,

m is based on a molar average 5, and

a is based on a molar average a number of from 5 to 8.

And more preferably:

R¹ and R² independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group,

n is based on a molar average 45,

m is based on a molar average 5, and

a is based on a molar average a number of from 6 to 7

are especially preferred.

In an alternative preferred example, the soil release polymers comprise copolymers having random blocks of ethylene terephthalate and polyethylene oxide (PEO) terephthalate. The molecular weight of this polymeric soil release agent is in the range of from about 25,000 to about 55,000. See U.S. Pat. No. 3,959,230 to Hays, issued May 25, 1976 and U.S. Pat. No. 3,893,929 to Basadur issued Jul. 8, 1975.

In an alternative preferred example, the soil release polymer is a polyester with repeat units of ethylene terephthalate units contains 10-15% by weight of ethylene terephthalate units together with 90-80% by weight of polyoxyethylene terephthalate units, derived from a polyoxyethylene glycol of average molecular weight 300-5,000. Examples of this polymer include the commercially available material ZELCON 5126 (from DuPont) and MILEASE T (from ICI). See also U.S. Pat. No. 4,702,857, issued Oct. 27, 1987 to Gosselink. Further examples of soil release polymers are terephthalic acid/glycol copolymers sold under the tradenames Texcare®, Repel-o-tex®, Gerol®, Marloquest® and, Cirrasol®.

In an alternative preferred example, the soil release polymer is a sulfonated product of a substantially linear ester oligomer comprised of an oligomeric ester backbone of terephthaloyl and oxyalkyleneoxy repeat units and terminal moieties covalently attached to the backbone. These soil release agents are described fully in U.S. Pat. No. 4,968,451, issued Nov. 6, 1990 to J. J. Scheibel and E. P. Gosselink. Other suitable polymeric soil release agents include the terephthalate polyesters of U.S. Pat. No. 4,711,730, issued Dec. 8, 1987 to Gosselink et al, the anionic end-capped oligomeric esters of U.S. Pat. No. 4,721,580, issued Jan. 26, 1988 to Gosselink, and the block polyester oligomeric compounds of U.S. Pat. No. 4,702,857, issued Oct. 27, 1987 to Gosselink.

Preferred polymeric soil release polymers also include the soil release agents of U.S. Pat. No. 4,877,896, issued Oct. 31, 1989 to Maldonado et al, which discloses anionic, especially sulfoarolyl, end-capped terephthalate esters.

In an alternative preferred example, the soil release agent is an oligomer with repeat units of terephthaloyl units, sulfoisoterephthaloyl units, oxyethyleneoxy and oxy-1,2-propylene units. The repeat units form the backbone of the oligomer and are preferably terminated with modified isethionate end-caps. A particularly preferred soil release agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)-ethanesulfonate. Said soil release agent also comprises from about 0.5% to about 20%, by weight of the oligomer, of a crystalline-reducing stabilizer, preferably selected from the group consisting of xylene sulfonate, cumene sulfonate, toluene sulfonate, and mixtures thereof.

In an alternative preferred example, the soil release polymers comprise polymers of aromatic dicarboxylic acids and alkylene glycols (including polymers containing polyalkylene glycols). For example, the soil release polymer may comprise a fabric-binding region formed from aromatic dicarboxylic acid/ester monomer units. Most preferably, the anionic soil release polymer is formed from aromatic dicarboxylic acid/ester and alkylene glycol units (including polymers containing polyalkylene glycols), such as those described in US 2013/0200290. Examples of suitable polymers include Texcare® SRA 100N or Texcare® SRA 300F marketed by Clariant®.

In a more preferred example, the soil release polymer may be according to the following formula (III):

X—[(EO)_{q1}-block-(PO)ₚ]—[(A-G₁—A—G₂)n]—B—G₁—B—[(PO)ₚ-block-(EO)_{q2}]—X Formula (III)

wherein EO is ethylene oxide (CH2CH2O) and PO is at least 80 wt % propylene oxide (CH2CH(CH3)O), and preferably 100% PO units;
where p is a number from 0 to 60, and when p is not zero is preferably from 2 to 50, more preferably from 5 to 45, even more preferably from 6 to 40, yet more preferably from 7 to 40 and most preferably from 8 to 40, even from 11 to 35;
where q1 and q2 is a number from 6 to 120, preferably 18 to 80, most preferably 40 to 70, provided that q2 is greater than p and preferably q2 is at least 1.5 times as large as p;
where n is a number from 2 to 26; preferably 5 to 15;

Because they are an average, n, p, q1 and q2 are not necessarily a whole number for the polymer in bulk.

where X is a capping moiety, preferably selected from C1-4 alkyl, branched and unbranched;

A and B are selected from ester, amide and urethane moieties, preferably the moieties A and B nearest to any PO blocks are esters, A and B may be different or may be the same;

when the moieties A and B adjacent to the PO blocks are esters then it is preferred that p is not zero, alternatively, it is preferred that the ratio of (q1+q2):n is from 4 to 10 and that q2 is from 40 to 120;

G1 comprises 1,4 phenylene;

G2 is ethylene, which may be substituted;

It is preferred that moieties G2 are all ethylene of formula (IV)

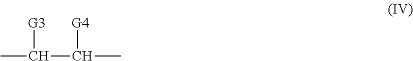

wherein G3 and G4 are selected from Hydrogen, C1-4 alkyl and C1-4 alkoxy, provided that at least one of G3 and G4 is not hydrogen and that at least 10% of the groups G2 have neither G3 nor G4 as hydrogen. Preferably when G3 and G4 are not hydrogen then they are methyl moieties. Preferably the non H substituents, more preferably the methyl moieties, are arranged in syn configuration on the ethylene backbone —CH—CH— of moieties G2.

### Silicone

The compositions of the present invention comprise silicone.

Silicone may be present at a level selected from: less than 10%, less than 5%, and less than 2.5%, by weight of the laundry composition. Silicone may be present at a level selected from: more than 0.01%, more than 0.05%, and more than 0.1%, by weight of the composition. Suitably silicone is present in the composition in an amount selected from the range of from about 0.01% to about 10%, preferably from about 0.05% to about 5%, more preferably from about 0.1% to about 2.5%, by weight of the composition.

Silicones and their chemistry are described in, for example in The Encyclopaedia of Polymer Science, volume 11, p765.

Silicones suitable for the present invention are fabric softening silicones. Non-limiting examples of such silicones include:
Non-functionalised silicones such as polydimethylsiloxane (PDMS),
Functionalised silicones such as alkyl (or alkoxy) functionalised, alkylene oxide functionalised, amino functionalised, phenyl functionalised, hydroxy functionalised, polyether functionalised, acrylate functionalised, siliconhydride functionalised, carboxy functionalised, phosphate functionalised, sulphate functionalised, phosphonate functionalised, sulphonic functionalised, betaine functionalised, quarternized nitrogen functionalised and mixtures thereof.
Copolymers, graft co-polymers and block co-polymers with one or more different types of functional groups such as alkyl, alkylene oxide, amino, phenyl, hydroxy, polyether, acrylate, siliconhydride, carboxy,
phosphate, sulphonic, phosphonate, betaine, quarternized nitrogen and mixtures thereof.

Suitable non-functionalised silicones have the general formula:

R1—Si(R3)2—O—[—Si(R3)2—O—]x-Si(R3)2—R2

R1=hydrogen, methyl, methoxy, ethoxy, hydroxy, propoxy, and aryloxy group.
R2=hydrogen, methyl, methoxy, ethoxy, hydroxy, propoxy, and aryloxy group.
R3=alkyl, aryl, hydroxy, or hydroxyalkyl group, and mixtures thereof

Suitable functionalised silicones may be anionic, cationic, or non-ionic functionalised silicones.

The functional group(s) on the functionalised silicones are preferably located in pendent positions on the silicone i.e. the composition comprises functionalised silicones wherein the functional group(s) are located in a position other than at the end of the silicone chain. The terms ‘terminal position’ and ‘at the end of the silicone chain’ are used to indicate the terminus of the silicone chain.

When the silicones are linear in nature, there are two ends to the silicone chain. In this case the anionic silicone preferably contains no functional groups located on a terminal position of the silicone.

When the silicones are branched in nature, the terminal position is deemed to be the two ends of the longest linear silicone chain. Preferably no functional group(s) are located on the terminus of the longest linear silicone chain.

Preferred functionalised silicones are those that comprise the anionic group at a mid-chain position on the silicone. Preferably the functional group(s) of the functionalised silicone are located at least five Si atoms from a terminal position on the silicone. Preferably the functional groups are distributed randomly along the silicone chain.

For best performance, it is preferred that the silicone is selected from: anionic functionalised silicone, non-functionalised silicone; and mixtures thereof. More preferably, the silicone is selected from: carboxy functionalised silicone; amino functionalised silicone; polydimethylsiloxane (PDMS) and mixtures thereof. Preferred features of each of these materials are outlined herein.

A carboxy functionalised silicone may be present as a carboxylic acid or an carbonate anion and preferably has a carboxy group content of at least 1 mol % by weight of the silicone polymer, preferably at least 2 mol %. Preferably the carboxy group(s) are located in a pendent position, more preferably located at least five Si atoms from a terminal position on the silicone. Preferably the caboxy groups are distributed randomly along the silicone chain. Examples of suitable carboxy functional silicones include FC 220 ex. Wacker Chemie and X22-3701E ex. Shin Etsu.

An amino functionalised silicone means a silicone containing at least one primary, secondary or tertiary amine group, or a quaternary ammonium group. The primary, secondary, tertiary and/or quaternary amine groups are preferably located in a pendent position, more preferably located at least five Si atoms from a terminal position on the silicone. Preferably the amino groups are distributed randomly along the silicone chain. Examples of suitable amino functional silicones include FC222 ex. Wacker Chemie and EC218 ex. Wacker Chemie.

A polydimethylsiloxane (PDMS) polymer has the general formula:

R1—Si(CH3)2—O—[—Si(CH3)2—O—]x —Si(CH3)2—R2

R1=hydrogen, methyl, methoxy, ethoxy, hydroxy, propoxy, and aryloxy group.
R2 =hydrogen, methyl, methoxy, ethoxy, hydroxy, propoxy, and aryloxy group.
A suitable example of a PDMS polymer is E22 ex. Wacker Chemie.
Most preferably the silicone is a carboxy functionalised silicone as described above.

The molecular weight of the silicone polymer is preferably from 1,000 to 500,000, more preferably from 2,000 to 250,000 even more preferably from 5,000 to 200,000.

The silicone of the present invention is preferably present in the form of an emulsion. Silicones are preferably emulsified prior to addition to the present compositions. Silicone compositions are generally supplied from manufacturers in the form of emulsions.

The average particle size of the emulsion is in the range from about 1 nm to 150 nm, preferably 1 nm to 100 nm. This may be referred to as a micro emulsion. The particle size is measured as a volume mean diameter, D[4,3], this can be measured using a Malvern Mastersizer 2000 from Malvern instruments.

### Cationic Polymer

The laundry composition of the present invention comprises a cationic polymer. This refers to polymers having an overall positive charge.

The cationic polymer may be naturally derived or synthetic. Examples of suitable cationic polymers include: acrylate polymers, cationic amino resins, cationic urea resins, and cationic polysaccharides, including: cationic celluloses, cationic guars and cationic starches.

The cationic polymer of the present invention may be categorised as a polysaccharide-based cationic polymer or non-polysaccharide based cationic polymers.

Polysaccharide-based cationic polymers:

Polysacchride based cationic polymers include cationic celluloses, cationic guars and cationic starches. Polysaccharides are polymers made up from monosaccharide monomers joined together by glycosidic bonds.

The cationic polysaccharide-based polymers present in the compositions of the invention have a modified polysaccharide backbone, modified in that additional chemical groups have been reacted with some of the free hydroxyl groups of the polysaccharide backbone to give an overall positive charge to the modified cellulosic monomer unit.

A preferred polysaccharide polymer is cationic cellulose. This refers to polymers having a cellulose backbone and an overall positive charge.

Cellulose is a polysaccharide with glucose as its monomer, specifically it is a straight chain polymer of D-glucopyranose units linked via beta—1,4 glycosidic bonds and is a linear, non-branched polymer.

The cationic cellulose-based polymers of the present invention have a modified cellulose backbone, modified in that additional chemical groups have been reacted with some of the free hydroxyl groups of the polysaccharide backbone to give an overall positive charge to the modified cellulose monomer unit.

A preferred class of cationic cellulose polymers suitable for this invention are those that have a cellulose backbone modified to incorporate a quaternary ammonium salt. Preferably the quaternary ammonium salt is linked to the cellulose backbone by a hydroxyethyl or hydroxypropyl group. Preferably the charged nitrogen of the quaternary ammonium salt has one or more alkyl group substituents.

Example cationic cellulose polymers are salts of hydroxyethyl cellulose reacted with trimethyl ammonium substituted epoxide, referred to in the field under the International Nomenclature for Cosmetic Ingredients as Polyquatemium 10 and is commercially available from the Amerchol Corporation, a subsidiary of The Dow Chemical Company, marketed as the Polymer LR, JR, and KG series of polymers. Other suitable types of cationic celluloses include the polymeric quaternary ammonium salts of hydroxyethyl cellulose reacted with lauryl dimethyl ammonium—substituted epoxide referred to in the field under the International Nomenclature for Cosmetic Ingredients as Polyquatemium 24. These materials are available from Amerchol Corporation marketed as Polymer LM-200.

Typical examples of preferred cationic cellulosic polymers include cocodimethylammonium hydroxypropyl oxyethyl cellulose, lauryldimethylammonium hydroxypropyl oxyethyl cellulose, stearyldimethylammonium hydroxypropyl oxyethyl cellulose, and stearyldimethylammonium hydroxyethyl cellulose; cellulose 2-hydroxyethyl 2-hydroxy 3-(trimethyl ammonio) propyl ether salt, polyquaternium-4, polyquaternium-10, polyquaternium-24 and polyquaternium-67 or mixtures thereof.

More preferably the cationic cellulosic polymer is a quaternised hydroxy ether cellulose cationic polymer. These are commonly known as polyquaternium-10. Suitable commercial cationic cellulosic polymer products for use according to the present invention are marketed by the Amerchol Corporation under the trade name UCARE.

The counterion of the cationic polymer is freely chosen from the halides: chloride, bromide, and iodide; or from hydroxide, phosphate, sulphate, hydrosulphate, ethyl sulphate, methyl sulphate, formate, and acetate.

Non polysaccharide-based cationic polymers:

A non-polysaccharide-based cationic polymer is comprised of structural units, these structural units may be non-ionic, cationic, anionic or mixtures thereof. The polymer may comprise non-cationic structural units, but the polymer must have a net cationic charge.

The cationic polymer may consists of only one type of structural unit, i.e., the polymer is a homopolymer. The cationic polymer may consists of two types of structural units, i.e., the polymer is a copolymer. The cationic polymer may consists of three types of structural units, i.e., the polymer is a terpolymer. The cationic polymer may comprises two or more types of structural units. The structural units may be described as first structural units, second structural units, third structural units, etc. The structural units, or monomers, may be incorporated in the cationic polymer in a random format or in a block format.

The cationic polymer may comprise a nonionic structural units derived from monomers selected from: (meth)acrylamide, vinyl formamide, N, N-dialkyl acrylamide, N, N-dialkylmethacrylamide, C1-C12 alkyl acrylate, C1-C12 hydroxyalkyl acrylate, polyalkylene glyol acrylate, C1-C12 alkyl methacrylate, C1-C12 hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and mixtures thereof.

The cationic polymer may comprise a cationic structural units derived from monomers selected from: N, N-dialkylaminoalkyl methacrylate, N, N-dialkylaminoalkyl acrylate, N, N-dialkylaminoalkyl acrylamide, N, N-dialkylaminoalkylmethacrylamide, methacylamidoalkyl trialkylammonium salts, acrylamidoalkylltrialkylamminium salts, vinylamine, vinylimine, vinyl imidazole, quaternized vinyl imidazole, diallyl dialkyl ammonium salts, and mixtures thereof.

Preferably, the cationic monomer is selected from: diallyl dimethyl ammonium salts (DADMAS), N, N-dimethyl aminoethyl acrylate, N,N-dimethyl aminoethyl methacrylate (DMAM), [2-(methacryloylamino)ethyl]trl-methylammonium salts, N, N-dimethylaminopropyl acrylamide (DMAPA), N, N-dimethylaminopropyl methacrylamide (DMAPMA), acrylamidopropyl trimethyl ammonium salts (APTAS), methacrylamidopropyl trimethylammonium salts (MAPTAS), quaternized vinylimidazole (QVi), and mixtures thereof.

The cationic polymer may comprise anionic structural units derived from monomers selected from: acrylic acid (AA), methacrylic acid, maleic acid, vinyl sulfonic acid, styrene sulfonic acid, acrylamidopropylmethane sulfonic acid (AMPS) and their salts, and mixtures thereof.

Some cationic polymers disclosed herein will require stabilisers i.e. materials which will exhibit a yield stress in the ancillary laundry composition of the present invention. Such stabilisers may be selected from: thread like structuring systems for example hydrogenated castor oil or trihydroxystearin e.g. Thixcin ex. Elementis Specialties, crosslinked polyacrylic acid for example Carbopol ex. Lubrizol and gums for example carrageenan.

Preferably the cationic polymer is selected from; cationic polysaccharides and acrylate polymers. More preferably the cationic polymer is a cationic acrylate polymer or a cationic cellulose.

The molecular weight of the cationic polymer is preferably greater than 20 000 g/mol, more preferably greater than 25 000 g/mol. The molecular weight is preferably less than 2 000 000 g/mol, more preferably less than 1 000 000 g/mol.

Cationic polymer may be present at a level selected from: less than 10%, less than 7.5%, and less than 5%, by weight of the laundry composition. Cationic polymer may be present at a level selected from: more than 0.005%, more than 0.01%, and more than 0.1%, by weight of the composition. Suitably cationic polymer is present in the composition in an amount selected from the range of from about 0.005% to about 10%, preferably from about 0.01% to about 7.5%, more preferably from about 0.1% to about 5%, by weight of the composition.

### Ratios of Materials

Preferably the levels of soil release polymer to silicone and silicone to cationic polymer are proportional to each other.

A preferred ratio of soil release polymer to silicone is in the range of 10:1 to 1:10, more preferably 5:2 to 1:4.

A preferred ratio of silicone to cationic polymer is 10:1 to 1:1, more preferably 5:1 to 1:1.

### Surfactants

The compositions of the present invention preferably comprise a surfactant.

The surfactant may be anionic, cationic, non-ionic and mixtures thereof.

The laundry compositions of the present invention generally comprise at least 3 w.t. % surfactant, preferably at least 5 w.t. %, more preferably at least 8 w.t. %. Generally, the composition will comprise less than 60 w.t. % surfactant, more preferably less than 50 w.t. %, most preferably less than 40 w.t. % of one or more surfactants. Suitably the composition may comprise 3 to 60 w.t. %, more preferably 5 to 50 w.t. %, most preferably 8 to 40 w.t. % of one or more surfactants.

Preferably the surfactants are detersive surfactants, which may be selected from anionic surfactants, nonionic surfactants and mixtures thereof.

Anionic surfactants for use in the invention are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, alkyl ether sulfates, alkaryl sulfonates, alpha-olefin sulfonates and mixtures thereof. The alkyl radicals preferably contain from 10 to 18 carbon atoms and may be unsaturated. The alkyl ether sulfates may contain from one to ten ethylene oxide or propylene oxide units per molecule, and preferably contain one to three ethylene oxide units per molecule. The counterion for anionic surfactants is generally an alkali metal such as sodium or potassium; or an ammoniacal counterion such as monoethanolamine, (MEA) diethanolamine (DEA) or triethanolamine (TEA). Mixtures of such counterions may also be employed.

A preferred class of anionic surfactant for use in the invention includes alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ.

Also suitable are alkyl ether sulfates having a straight or branched chain alkyl group having 10 to 18, more preferably 12 to 14 carbon atoms and containing an average of 1 to 3EO units per molecule. A preferred example is sodium lauryl ether sulfate (SLES) in which the predominantly C12 lauryl alkyl group has been ethoxylated with an average of 3EO units per molecule.

Some alkyl sulfate surfactant (PAS) may be used, such as non-ethoxylated primary and secondary alkyl sulphates with an alkyl chain length of from 10 to 18.

Preferred anionic surfactants are selected from: linear alkyl benezene sulphonates, sodium lauryl ether sulphonates with 1 to 3 moles (average) of ethoxylation, primary alkyl sulphonates, methyl ether sulphates and secondary alkyl sulphonates or mixtures thereof.

Mixtures of any of the above described materials may also be used. A preferred mixture of anionic surfactants for use in the invention comprises linear alkylbenzene sulfonate (preferably C₁₁ to C₁₅ linear alkyl benzene sulfonate) and sodium lauryl ether sulfate. (preferably C₁₀ to C₁₈ alkyl sulfate ethoxylated with an average of 1 to 3 EO) The total level of anionic surfactant in the present invention may suitably range from 5 to 30 w.t. %.

Nonionic surfactants for use in the invention are typically polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and aliphatic alcohol ethoxylates such as C₈ to C₁₈ primary or secondary linear or branched alcohol ethoxylates with an average of from 2 to 40 moles of ethylene oxide per mole of alcohol.

A preferred class of nonionic surfactant for use in the invention includes aliphatic C₈ to C₁₈, more preferably C₁₂ to C₁₅ primary linear alcohol ethoxylates with an average of from 3 to 20, more preferably from 5 to 10 moles of ethylene oxide per mole of alcohol.

Mixtures of any of the above described materials may also be used.

The total level of nonionic surfactant in the present invention may suitably range from 0 to 25 w.t. %.

Examples of suitable mixtures of anionic and/or nonionic surfactants for use in the invention include mixtures of linear alkylbenzene sulfonate (preferably C₁₁ to C₁₅ linear alkyl benzene sulfonate) with sodium lauryl ether sulfate (preferably C₁₀ to C₁₈ alkyl sulfate ethoxylated with an average of 1 to 3 EO) and/or ethoxylated aliphatic alcohol (preferably C₁₂ to C₁₅ primary linear alcohol ethoxylate with an average of from 5 to 10 moles of ethylene oxide per mole of alcohol). The level of linear alkylbenzene sulfonate (preferably C₁₁ to C₁₅ linear alkyl benzene sulfonate) in such mixtures is preferably at least 50%, such as from 50 to 95% (by weight based on the total weight of the mixture).

Where an anionic and a non-ionic surfactant are present in the laundry detergent, the weight ratio of anionic to nonionic surfactant may be from 5:1 to 1:1.5. Preferably the weight ratio of anionic to nonionic surfactant is from 5:1 to 1:1.25, more preferably from 4:1 to 1:1.25, even more preferably from 4:1 to 1:1.

### Cosurfactants

When detersive surfactants are present in the compositions of the present invention, the composition may further comprise one or more cosurfactants (such as amphoteric (zwitterionic) and/or cationic surfactants) in addition to the anionic and/or nonionic detersive surfactants described above.

Specific cationic surfactants include C8 to C18 alkyl dimethyl ammonium halides and derivatives thereof in which one or two hydroxyethyl groups replace one or two of the methyl groups, and mixtures thereof. Cationic surfactant, when included, may be present in an amount ranging from 0.1 to 5% (by weight based on the total weight of the composition).

Specific amphoteric (zwitterionic) surfactants include alkyl amine oxides, alkyl betaines, alkyl amidopropyl betaines, alkyl sulphobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms, the term “alkyl” being used to include the alkyl portion of higher acyl radicals. Amphoteric (zwitterionic) surfactant, when included, may be present in an amount ranging from 0.1 to 5% (by weight based on the total weight of the composition).

Mixtures of any of the above described materials may also be used.

### Builders

When detersive surfactants are present in the compositions of the present invention, the composition may further comprise one or more builders. Builders enhance or maintain the cleaning efficiency of the surfactant. Builders for use in the invention can be of the organic or inorganic type, or a mixture thereof. Non-phosphate builders are preferred. Inorganic, non-phosphate builders for use in the invention are preferably selected from: hydroxides, carbonates, silicates, zeolites, and mixtures thereof.

The overall level of builder, when included, may range from about 0.1 to about 80%, preferably from about 0.5 to about 50% (by weight based on the total weight of the composition). Preferably the level of phosphate builders in a liquid laundry detergent of the invention is no more than 1%.

### Fatty Acid

When detersive surfactants are present in the compositions of the present invention, the composition may further comprise one or more fatty acids and/or salts thereof.

Suitable fatty acids in the context of this invention include aliphatic carboxylic acids of formula RCOOH, where R is a linear or branched alkyl or alkenyl chain containing from 6 to 24, more preferably 10 to 22, most preferably from 12 to 18 carbon atoms and 0 or 1 double bond. Preferred examples of such materials include saturated C12-18 fatty acids such as lauric acid, myristic acid, palmitic acid or stearic acid; and fatty acid mixtures in which 50 to 100% (by weight based on the total weight of the mixture) consists of saturated C12-18 fatty acids. Such mixtures may typically be derived from natural fats and/or optionally hydrogenated natural oils (such as coconut oil, palm kernel oil or tallow).

The fatty acids may be present in the form of their sodium, potassium or ammonium salts and/or in the form of soluble salts of organic bases, such as mono-, di- or triethanolamine. Mixtures of any of the above described materials may also be used.

Fatty acids and/or their salts, when included, may be present in an amount ranging from about 0.25 to 5%, more preferably from 0.5 to 5%, most preferably from 0.75 to 4% (by weight based on the total weight of the composition). For formula accounting purposes, in the formulation, fatty acids and/or their salts (as defined above) are not included in the level of surfactant or in the level of builder.

### Dye Transfer Inhibitors

Modern detergent compositions typically employ polymers as so-called ‘dye-transfer inhibitors’. These prevent migration of dyes, especially during long soak times. Generally, such dye-transfer inhibiting agents include polyvinyl pyrrolidone polymers, polyamine N-oxide polymers, copolymers of N-vinylpyrrolidone and N-vinylimidazole, manganese pthalocyanine, peroxidases, and mixtures thereof, and are usually present at a level of from 0.01 to 10 wt. % based on total amount in the laundry composition.

### Anti-Redeposition Polymers

Anti-redeposition polymers are designed to suspend or disperse soil. Typically antiredeposition polymers are ethoxylated and or propoxylated polyethylene imine or polycarboxylate materials, for example, Acrylic acid based homo or copolymers available under the trade mark ACUSOL from Dow Chemical, Alcosperse from Akzonobel or Sokolan from BASF.

### Enzymes

Enzymes can also be present in the formulation. Preferred enzymes include protease, lipase, pectate lyase, amylase, cutinase, cellulase, mannanase. If present the enzymes may be stabilized with a known enzyme stabilizer for example boric acid.

Other Ingredients

When detersive surfactants are present in the compositions of the present invention, the compositions may comprise further ingredients typically found in fabric detergent compositions. Such materials include: transition metal ion chelating ingredients, hydrotropes, shading dyes, fluorescent agents, enzymes,

### Perfumes

The laundry compositions of the present invention may preferably comprise 0.1 to 15 w.t. % free perfume, more preferably 0.5 to 8 w.t. % free perfume.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Particularly preferred perfume components are blooming perfume components and substantive perfume components. Blooming perfume components are defined by a boiling point less than 250° C. and a LogP or greater than 2.5. Substantive perfume components are defined by a boiling point greater than 250° C. and a LogP greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

### Method of use

The compositions of the present invention may be used in a method for softening knitted cotton. Softening may be described as fabric care or fibre care. Preferably the knitted cotton is treated with the composition during the wash process.

It is preferred that the composition of the present invention is a detergent composition, in which case, the treatment is preferably in the main wash. If the composition of the present invention is a fabric conditioner, the treatment is preferably in the rinse.

Preferably the compositions of the present invention are dosed in a volume of 10 g to 200 g, more preferably 20 g to 150 g.

### Use of the Composition

The composition of the present invention may be used for softening knitted cotton. One method of measuring softening is by measuring friction of the treated fabrics.

### Examples

### Soil Release Polymers and Cotton

It is generally known that soil release polymers do not deposit on cotton. To demonstrate this the following example was carried out:

TABLE 1
Powder formulations

| | | Y |
|---|---|---|
| Ingredient | X | (With SRP) |
| LAS acid | 24 | 24 |
| STPP | 14.5 | 14.5 |
| Sodium carbonate | 17.5 | 17.5 |
| Sodium silicate | 8.0 | 8.0 |
| Soil release polymer | 0 | 0.5 |
| Minors (enzymes, fragrance) | <5 | <5 |
| Sodium Sulphate | To 100% | To 100% |

3 pieces of polyester and 3 pieces of cotton were washed in each of formulations X and Y. The pieces of fabric were washed 5 times in the test formulations and line dried between each wash. The powder was added as 1.3g/l.

Washing conditions:
Wash temperature: 28° C.
Water hardness: 27FH
Wash time: 10 mins
Rinses: 2

The pieces of fabric were then stained with olive oil (which contained solvent violet dye at 0.2%). 3×35mm stains were then applied to each piece of fabric.

Stains were allowed to dry. The stain intensity was measured on a spectrophotometer at a reflectance of 580 nm.

Monitors were then rewashed in the test formulation X or Y and the reflectance was re-measured.

TABLE 2
Results

| | Average | Average |
|---|---|---|
| | reflectance | reflectance |
| Ingredient | before washing | after washing |
| Polyester | 25.9 | 52.0 |
| Cotton | 14.9 | 14.8 |

Higher numbers indicated greater stain removal. This shows that the soil release polymer deposited onto polyester and lead to stain removal. However, there was no stain removal from cotton. This demonstrates good deposition onto polyester but no deposition onto cotton.

### Example Formulations

TABLE 3
Example formulations

| Ingredient | A | 1 | 2 |
|---|---|---|---|
| Glycerol | 2.0 | 2.0 | 2.0 |
| Monopropylene glycol | 4.0 | 4.0 | 4.0 |
| TEA | 1.5 | 1.5 | 1.5 |
| MEA | 2.25 | 2.25 | 2.25 |
| Citric acid | 1.25 | 1.25 | 1.25 |
| Neodol 25-7 | 3.5 | 3.5 | 3.5 |
| LAS acid | 5 | 5 | 5 |
| Fatty acid | 1.25 | 1.25 | 1.25 |
| SLES | 3.5 | 3.5 | 3.5 |
| Cationic polymer ¹ | 0.2 | 0.07 | 0.53 |
| Active Silicone² | 0.5 g | 0.5 g | 0.5 g |
| NaOH | to pH | to pH | to pH |
| | 8.0-8.5 | 8.0-8.5 | 8.0-8.5 |
| Water | to 100 | to 100 | to 100 |
| Addition before wash | — | | — |
| Soil release polymer ³ | 0 | 0.35 g | 1 g |

Cationic polymer ¹ - UCare Polymer LR400 ex. Dow. This is a Polyquaternium-10 polymer.
Active Silicone² - Silicone added as a 30% Silicone emulsion. The silicone comprised a carboxy group in a mid-chain pendent position ex. Wacker.
SRN170 ³- TexCare SRN 170 ex. Clariant. This is a nonionic soil release polyester

### Method of Manufacture

Water and hydrotropes were mixed together at ambient temperature for 2-3 minutes at a shear rate of 150 rpm using a Janke & Kunkel IKA RW20 overhead mixer. Salts and alkalis were added and mixed for 5 minutes prior to addition of surfactants and fatty acid. The mixture was exothermic and allowed to cool to <30° C. The deposition polymer¹ silicone emulsion² and any remaining components such as perfume, preservatives and dyes are added.

The soil release polymers were added separately before adding the composition to the wash.

### Wash Experiment

35m1 of formulation A was dosed into a dosing ball, followed by soil release polymer where required. The mixture was stirred for 2 minutes before addition to the drum of the washing machine.

The fabrics were then washed using the cotton short cycle at 40° C. of a Miele automatic washing machine. After the cycle the fabrics were line dried. This process was repeated 6 times.

### Softness Measurement

Softness was measured by friction on the fabric. The friction was measured using a Texture Analyser (TA.XT plus ex. Stable Micro Systems) with the optional friction module attached. The Texture Analyser is a commercial instrument incorporating a drive mechanism and a 5 kg load cell. The treated fabric was laid on the horizontal test platform of the instrument and a neoprene rubber cylindrical probe which is attached to the load cell was placed on the fabric surface. The texture analyser is programmed to move the probe over a distance of 40 mm forwards and backwards over the fabric at a speed of 10 mm/s. As the probe moves the software records the frictional force experienced by the probe. The average friction coefficient over the whole test is used as a measure of softness. 25 readings from 25 different positions were randomly selected from the fabric.

### Results

TABLE 4
Results

Knitted Cotton

| | Friction | Standard |
|---|---|---|
| | coefficient | deviation |
| A | 1.167 | 0.028 |
| 1 | 1.055 | 0.034 |
| 2 | 1.079 | 0.031 |

The friction of knitted cotton is lower when treated with a composition comprising soil release polymer and silicone, than when treated with just silicone on its own. Lower friction is indicative of a softer feel.

1-14. (canceled)

15. A method for softening knitted cotton, wherein the knitted cotton is treated with a laundry composition comprising:
a. soil release polymer;
b. silicone;
c. cationic polymer;
d. surfactant; and
e. water
wherein the ratio of soil release polymer to silicone is 10:1 to 1:10.

16. The method according to claim 15, wherein the ratio of silicone to cationic polymer is 10:1 to 1:1.

17. The method according to claim 15, wherein the soil release polymer is present in an amount of 0.005 to 7.5 wt. % of the composition.

18. The method according to claim 15, wherein the soil release polymer is selected from polymers according to the formula:
X1—R1—Z—R2—X2
wherein:
X₁ and X₂ are independently capping moieties;
R₁ and R₁ are independently one or more nonionic hydrophilic blocks; and
Z is one or more anionic hydrophobic blocks.

19. The method according to claim 15, wherein the silicone is present in a of level 0.01 to 10 wt. % of the composition.

20. The method according to claim 15, wherein the silicone is in the form of an emulsion.

21. The method according to claim 15, wherein the silicone comprises anionic functionality.

22. The method according to claim 15, wherein the silicone comprises carboxy functionality.

23. The method according to claim 15, wherein the cationic polymer is present in a of level 0.005 to 10 wt. % of the composition.

24. The method according to claim 15, wherein the cationic polymer is selected from cationic polysaccharides and cationic acrylate polymers.

25. The method according to claim 15, wherein the surfactant is selected from anionic surfactants, non-ionic surfactants and mixtures thereof.

26. The method according to claim 15, wherein the surfactant is present in a of level 3 to 60 wt. % of the composition.

27. A laundry composition comprising:
a. soil release polymer;
b. silicone;
c. cationic polymer;
d. surfactant; and
e. water
wherein the ratio of soil release polymer to silicone is 5:2 to 1:4 and the ratio of silicone to cationic polymer is 5:1 to 1:1, the composition suitable for softening knitted cotton.
